(19) United States
(12) Patent Application Publication
(10) Pub. No.: US 2006/0230456 A1
(43) Pub. Date: Oct. 12, 2006

(54) Methods and apparatus to maintain telecommunication system integrity

(75) Inventors: Gayathri Nagabhushan, Portland, OR (US); Priya Rajagopal, Wharton, NJ (US); Ravi Sahita, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/089,045

(22) Filed: Mar. 24, 2005

(51) Int. Cl. G06F 12/14; G06F 11/00; G06F 12/16; G06F 15/18; G08B 23/00

(52) U.S. Cl. 726/25; 726/24; 726/23

(57) ABSTRACT

A heuristic agent in a tamper resistant partition monitors network traffic flow for undesirable worm scanning activity. If the undesired scanning activity is detected, the output of an associated network controller may be throttled or ultimately disabled from the network.

### BACKGROUND

The present subject matter pertains to telecommunication systems and, more particularly, to methods and apparatus to maintain communication network security.

With the proliferation of computers and computer systems in modem communications and business, maintaining integrity of such complex systems has become of paramount importance. In such critical applications as telecommunication systems, a computer virus may inhibit or terminate the processing of all of or a portion of a telecommunication system. For example, networks or entire telecommunication systems may be infected.

A “virus” is a computer program or software that is located on a computer without a user's knowledge and that runs against the user's wishes. Computer viruses may be able to replicate themselves. A virus that can make a copy of itself without human intervention over and over again is termed a “worm”. In a telecommunication system environment this worm may transmit itself to other telecommunication system nodes or networks, etc.

In a telecommunication system setting, a key to the self-propagation of such computer viruses or worms is their ability to spread from one communication platform to another. A computer virus may spread to many nodes of communication platforms before a human user of a communication node even realizes the existence of the virus.

### BRIEF DESCRIPTION OF THE DRAWINGS

FIG. 1 is a block diagram of a telecommunication system in accordance with various embodiments of the present invention.

FIG. 2 is a flow chart of a method for telecommunication system security in accordance with various embodiments of the present invention.

FIG. 3 is a flow chart of a detailed method for telecommunication system security in accordance with various embodiments of the present invention.

### DETAILED DESCRIPTION

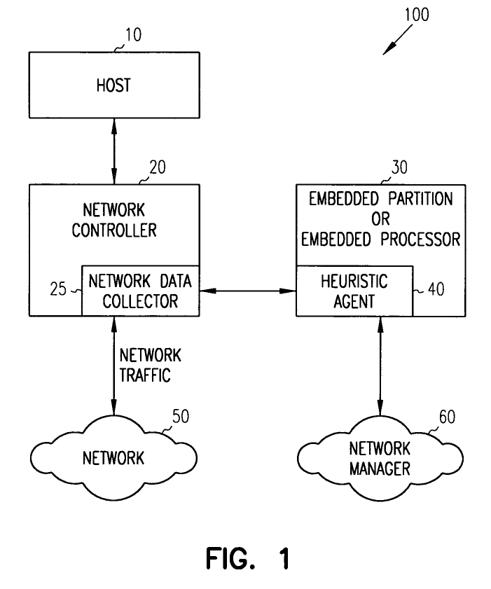

FIG. 1 is a block diagram of a telecommunication system in accordance with various embodiments of the present invention. Typically, telecommunication system 100 facilitates communication between various users (not shown) via network 50 through network controller 20 to host 10. Network traffic may be from the host 10 to the network 50 or from the network 50 to the host 10. By the very nature of a telecommunication system transmitting data to and from various nodes of the system 100, the spread of computer viruses may be facilitated. Furthermore, some viruses such as worms may spread themselves via telecommunication system 100.

In an embodiment of the present invention, network controller 20 includes network data collector 25. Network data collector 25 is coupled to heuristic agent 40 of embedded processor or embedded partition 30.

“Heuristics” may refer to any combination of rules applied to analyze communication network traffic patterns. Heuristic analysis may be performed by heuristic agent 40. Heuristic-based analysis may be the ability to identify a potential worm or virus by analyzing the behavior of a program's interaction with the network. The program may execute on host 10.

A computer worm is typically a program or software that self-propagates across a communication network or system and exploits security or policy flaws of the system. Heuristic-based analysis captures the behavior of computer worms that may infect systems using heuristic behavior observation.

Embedded partition or embedded processor 30 also executes the software or program of heuristic agent 40.

Under appropriate conditions heuristic agent 40 may detect a computer worm or virus and either throttle back network controller 20 from transmitting and receiving network traffic or may totally disconnect network controller 20 from network 50. When network controller 20 is disconnected from the network 50, heuristic agent 40 may send a suitable message and alarm indication to network manager 60.

Heuristic agent 40 may be located on an isolated, embedded partition or embedded processor 30 that is co-located with network controller 20 on a particular platform. The isolated embedded partition or embedded processor 30 may be isolated from the main host operating system 10 and provide heuristic-based analysis with a tamper-resistant environment. Moreover, by co-locating the isolated partition with a network controller 20, heuristic agent 40 may periodically query and analyze network statistical data of network data collector 25. By using a low cost, low power embedded controller to provide the isolated partitioned environment for partition 30, a cost-effective solution can be implemented on different platforms, such as clients, servers, and/or other suitable platforms.

In-line network traffic may proceed from the host 10 through network controller 20, through network 50 to other network nodes (not shown), and it may also proceed through network 50, through network controller 20 to host 10. Data is collected by network data collector 25 in this “in-line” environment. The data is transmitted to heuristic agent 40, which operates in an off-line or “side-band” execution to analyze the data, searching for computer viruses. As a result, very little of the network controller 20 bandwidth is absorbed for the data collection function of network data collector 25. Since computer viruses and worms may propagate rapidly, heuristic agent 40 performs a fast analysis to detect these computer viruses. For example, memory round-trip time latencies and data-caching techniques may be employed.

Network data collector 25 gathers information “in-line” from the network traffic and may gather network statistical information for periodic analysis by heuristic agent 40. An implementation of this may comprise hardware within the network controller 20 or co-location of the network controller 20 with the embedded partition 30, as mentioned above. The information gathered by network data collector 25 may be pushed to heuristic agent 40 under the control of network data collector 25. Alternatively, the information gathered by data collector 25 may be periodically requested by heuristic agent 40.

Let us consider an example of a self-propagating virus or worm entering the network traffic via network 50. The virus or worm is transmitted through network controller 20 to host 10. A danger to the telecommunication system 100 and network 50 is the computer virus or worm entering a phase called self-propagation. The self-propagation phase indicates that the computer virus or worm will attempt to propagate via the network 50 to other hosts and network nodes (not shown) of the telecommunication system 100.

Typically, in order for a computer virus or worm to propagate, the virus or worm enters a reconnaissance phase. That is, the virus or worm begins a scanning operation for other potential victims on the network 50. The scanning operation or activity is undesirable and is generally for malicious purposes. The scanning activity of the virus or worm is recorded by the network data collector 25. The results of the in-line data collection are either pushed or periodically requested by heuristic agent 40.

Heuristic agent 40 then applies heuristics (a set of rules) in order to detect this undesired scanning activity. If the undesired scanning activity is found by heuristic agent 40, heuristic agent 40 may instruct network controller 20 to throttle back the amount of network traffic that it is handling. Network controller 20 will then reduce the traffic that is passing through it in order to determine whether the scanning is part of an administrative program or a computer virus or worm.

If heuristic agent 40 detects the undesired scanning activity of a computer virus or worm, it will then instruct network controller 20 to disconnect from network 50 and to transmit no further traffic to or from the network 50. In addition, heuristic agent 40 will then send an alert indication to network manager 60, indicating that network controller 20 has been disconnected. This disconnection of network controller 20 from the network may be called a “circuit breaker” action. The “circuit breaker” action may be analogous to an electrical circuit breaker in a home or office that operates upon the detection of excessive current requirements and opens the circuit so as to disconnect the particular device(s).

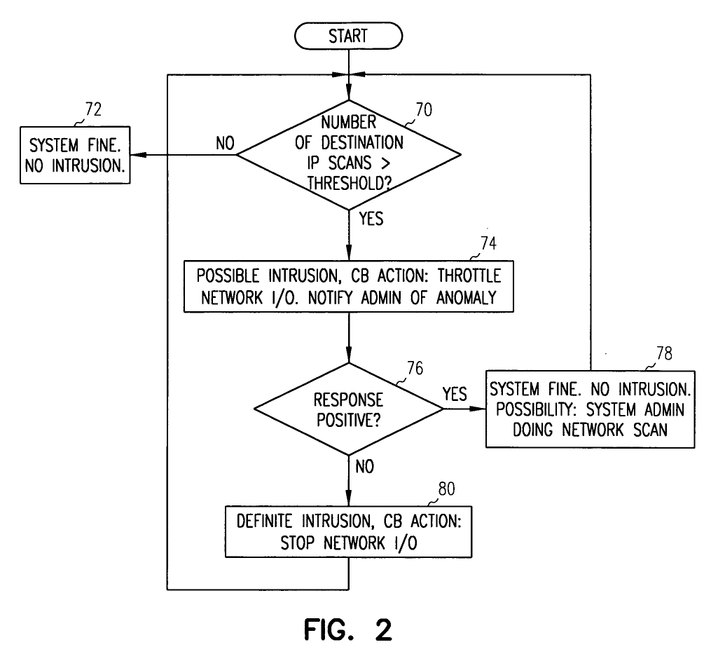

FIG. 2 is a flow chart of a method for telecommunication system security in accordance with various embodiments of the present invention. The flow chart depicted is a high-level view of the methodology of the heuristic agent 40, for example. Other heuristic functions may be accommodated by this method. This method is started, and block 70 is entered. Heuristic agent 40 determines whether the number of destination Internet protocol (IP) scans is greater than a selected or predetermined threshold. The threshold may be an engineerable number. The system operator may select different values based upon a unit of time. For example, the system operator may select a threshold of 50 address scans in a time period of less than a second. This level of address-scanning activity from one source is clearly a scanning operation. And if this scanning operation is not being performed by a legitimate administrative system program, the assumption is that it is probably being performed by a computer virus or worm.

One example of a heuristic rule might be, if on a specific port the number of Transmission Control Protocol/Internet Protocol (TCP/IP) connections is greater than or equal to 50 and was attempted in a time period of less than or equal to one second. A computer virus or worm is probably the cause of such undesired and malicious scanning activity.

If the number of destination IP scans is less than the threshold, block 70 transfers control to block 72 via the NO path. Block 72 determines that the system is operating properly and no computer virus or worm intrusion has been detected. Block 72 then transfers control back to block 70 to iterate the heuristic checking process.

If the number of destination scans exceeds the threshold, block 70 transfers control to block 74 via the YES path. A possible intrusion is detected from a computer virus or worm. In an embodiment of the present invention, a first level “circuit breaker” (CB) type of action may be to throttle the network input/output of the network controller 20 and to notify the network manager or administrator of the anomaly. That is, heuristic agent 40 will instruct network controller 20, through network data controller 25, to transmit very few data packets to network 50.

If a network administrator or system program is sending a great number of data packets outward to network 50, the number of these data packets transmitted will be diminished. If a computer virus or a worm is continuing to transmit, it will transmit at a maximum rate, and the number of scans will not fall below the threshold value. This is a negative response to the throttling operation. If a positive response to the throttling operation is detected, block 76 will transfer control to block 78 via the YES path. The telecommunication system 100 is operating properly, and no computer virus or worm intrusion is detected. There is a possibility that the system administrative software was scanning by sending data packets out to various destination addresses. Block 78 then transfers control back to block 70 to again perform the heuristic checking process.

If a non-positive response (i.e. a negative response) is obtained from the throttling activity, a computer worm or virus has been detected. Block 80 then takes “circuit breaker” type action to disconnect network controller 20 from network 50. Further, heuristic agent 40 may report the disconnection to network manager 60. Block 80 then transfers control to block 70 to re-initiate the heuristic checking process.

To summarize, the software of the heuristic agent 40 collects scanning information or data by the network data or information collector 25. Network controller 20 and network data collector 25 are associated with network 50 for network traffic flow to and from host 10. Heuristic agent 40 determines whether the scanning information includes a number of IP destination scans from a source that exceeds a threshold established by a network operator.

If the number of IP destination scans by a single source exceeds the threshold value, the heuristic agent 40 instructs network controller 20, through network data collector 25, to inhibit communications between network controller 20 and the network 50. As pointed out above, a first level of communication-inhibiting may be performed by adjusting the traffic flow between the network controller and the network. That is, heuristic agent 40 may substantially reduce the amount of data packets transmitted by network controller 20. The heuristic agent 40 may then determine a second time, if the number of Internet protocol destination scans is less than the threshold. If not, the traffic flow between network controller 20 and network 50 may be completely stopped, and an alarm indication may be transmitted to the network manager 60.

Referring again to FIG. 1, the telecommunication system 100 has a network controller 20 that is coupled to host 10. The network controller 20 has a network data or information collector 25. The network data collector 25 collects destination-scanning information. Embedded partition or embedded processor 30 may provide for the execution of heuristic agent 40. Embedded processor 30 may include a tamper-resistant partition performing side-band analysis under heuristic rules to detect a number of destination scans from a source that exceed a threshold value.

Network controller 20 may be a wireless or a wire-line network controller. That is, network 50 may be a wireless network or a wire-line network or a combination of both kinds of wireless and wire-line networks. If heuristic agent 40 detects a number of destination scans that exceeds the threshold, heuristic agent 40 instructs network controller 20 to adjust network traffic flow through network controller 20. The adjustment may be to completely terminate the flow of traffic. Alternatively, a partial termination of traffic or an increase of network traffic is possible.

Further, embedded partition or embedded processor 30, including heuristic agent 40 may be implemented on or comprise a portion of a network interface card (NIC) inserted into a circuit card slot.

Embedded partition or embedded processor 30, including and heuristic agent 40, may each be implemented on a semiconductor chip. In other embodiments, embedded partition or embedded processor 30 as well as heuristic agent 40 may be implemented on a chip set. However, the implementation is not limited to these configurations. A “chip” is a semiconductor device.

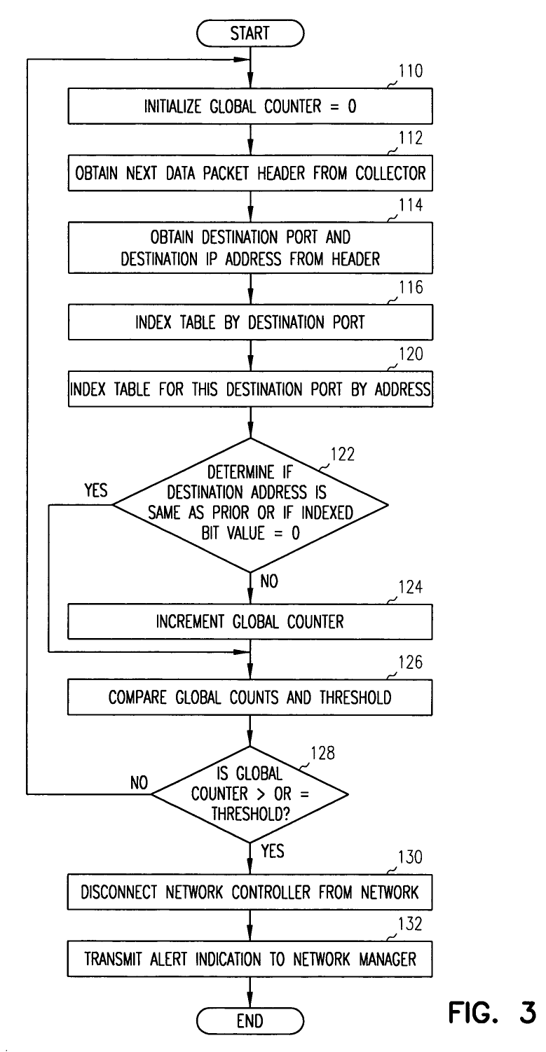

FIG. 3 is a flow chart of a detailed method for telecommunication system security in accordance with various embodiments of the present invention. The flow chart is an example an embodiment of heuristic rules that may be analyzed. Other heuristic rules may be applied using the same methodology. A method of heuristic rules of heuristic agent 40 (refer to FIG. 1) is begun, and block 110 is entered. A global counter is initialized and set equal to zero, block 110. Block 112 then obtains a next data packet header from network data collector 25. From the packet data header, block 114 obtains the destination port and destination Internet protocol (IP) address.

A table (not shown) is indexed by the destination port obtained from the data packet header, block 116. For the particular destination port entry in the table, the table is indexed by the IP address, block 120.

A determination is made whether the destination IP address is the same as the prior destination IP address or whether the bit value indexed in the table is zero, block 122. If not, block 122 transfers control to block 124 via the NO path. Block 124 increments the global counter by 1. If the determination indicates that the IP address was the same as the prior IP address, block 122 transfers control to block 126 via the YES path.

Block 126 compares the global counter and the threshold. Block 128 determines whether the global counter is greater than or equal to the threshold. If not, block 128 transfers control via the NO path to block 112 to perform the method again. If the global counter is greater than or equal to the threshold, block 128 transfers control to block 130 via the YES path.

Block 130 is initiated, and heuristic agent 40 automatically disconnects network controller 20 from the network 50. Lastly, block 132 is executed, and heuristic agent 40 transmits an alert indication to network manager 60 of the outage of network controller 20. The process is then ended. In an alternate embodiment, block 130 may adjust traffic flow as a first-level measure before reaching a decision that the cause is definitely a computer virus or worm.

It should be noted that the methods described herein do not have to be executed in the order described, or in any particular order. Moreover, various activities described with respect to the methods identified herein can be executed in serial or parallel fashion.

It will be understood that although “Start” and “End” blocks are shown, the method may be performed continuously.

As mentioned earlier in the “Background” section, computer viruses are programmed to do harm to a computing platform. Computer viruses may be spread from one computer to another by human beings sending executable files to unsuspecting users.

A worm is similar to a computer virus, but unlike a virus, it has the ability to travel without any help from a human being. A worm may take advantage of file or information transport features of a telecommunication system that allow it to travel unaided. Worms have the ability to replicate themselves. For example, one worm might send out hundreds or thousands of copies of itself to other computers or communication nodes. For example, all the addresses in an email address book may be used to transmit the worm.

Computer worms may scan and send copies of itself at a high rate, and detection of such by human beings is typically impossible. As a result, the heuristic agent 40 and network data collector 25 operate to rapidly detect computer viruses or worms at the speed of software.

Although some embodiments of the invention have been illustrated, and those forms described in detail, it will be readily apparent to those skilled in the art that various modifications may be made therein without departing from the spirit of these embodiments or from the scope of the appended claims.

What is claimed is:

1. A device comprising:
a processor to receive network information;
an agent to examine the network information for a scanning operation, the agent coupled to the processor; and
the agent to determine whether the scanning operation represents an undesired scanning activity.

2. The device as claimed in claim 1, wherein the processor includes an embedded processor.

3. The device as claimed in claim 1, wherein the processor and the agent comprise an isolated partition of a network.

4. The device as claimed in claim 3, further comprising:
a network information collector to accumulate scanning information, the network information collector being coupled to the isolated partition; and
the network information including the scanning information.

5. The device as claimed in claim 4, wherein the network information collector is further coupled to the processor and to the agent to periodically transmit the scanning information to the agent.

6. The device as claimed in claim 4, wherein the agent is to periodically request the scanning information from the network information collector, the network information collector being coupled to the isolated embedded partition.

7. The device as claimed in claim 1, wherein a network interface card includes the processor and the agent.

8. The device as claimed in claim 1, further comprising one or more semiconductor chips for implementing the processor and the agent.

9. The device as claimed in claim 1, wherein the agent is coupled to a network information collector to determine whether the network information from the network information collector includes a number of Internet protocol destination scans from a source that exceeds a threshold.

10. The device as claimed in claim 9, wherein the agent is coupled through the processor to a network manager, the agent to send an alarm indication to the network manager if the number of Internet protocol destination scans of a non-administrative program from the source exceeds the threshold.

11. The device as claimed in claim 10, wherein the agent is further coupled to a network controller, the agent to disconnect the network controller from a network if the number of Internet protocol destination scans exceeds the threshold.

12. The device as claimed in claim 1, wherein the undesired scanning activity is caused by a software virus or a computer worm.

13. A system comprising:
a network controller coupled to a host, the network controller including a data collector;
the data collector to collect destination-scanning information;
a processor, including a heuristic agent, coupled to the data collector;
the heuristic agent to determine whether the scanning information includes a number of destination scans from a source that exceeds a threshold; and
the network controller including a wireless network controller.

14. The system as claimed in claim 13, the processor including an isolated processor, the isolated processor coupled to the wireless network controller.

15. The system as claimed in claim 13, the heuristic agent to control traffic flow if the number of destination scans from the source exceeds the threshold.

16. A method comprising:
gathering information of scanning activity of a program; and
determining whether an undesired scanning activity occurs, the determining performed by an agent applying heuristics to the information.

17. The method of claim 16, wherein if the undesired scanning activity occurs, there is further included disconnecting a network controller from a network.

18. The method of claim 17, wherein there is further included sending an alarm to a network manager.

19. The method of claim 17, wherein there is further included transmitting the information to the agent.

20. The method of claim 19, the agent requesting the information from the network controller.

21. The method of claim 19, the network controller periodically transmitting the information to the agent.

22. The method of claim 17, the determining including determining whether a number of Internet protocol scans by the program exceeds a threshold value.

23. The method of claim 22, wherein if the number of destination Internet protocol scans by the program exceeds the threshold value, there is further included throttling back traffic flow between the network and the network controller.

24. The method of claim 22, further comprising: in response to the determining if the number of destination Internet protocol scans by the program exceeds the threshold value, there is further included automatically disconnecting the network controller from a network.

25. The method of claim 24, further comprising: in response to the determining if the number of destination Internet protocol scans by the program exceeds the threshold value, determining whether the program comprises an administrative program.

26. The method of claim 17, the determining whether an unauthorized scanning activity including determining whether a traffic pattern behavior of a computer worm is present.

27. A machine-accessible medium having associated instructions, wherein the instructions, when accessed, result in a machine performing:
collecting scanning information by a network information collector of a network;
determining by an agent whether the scanning information includes a number of Internet protocol scans from a source that exceeds a threshold; and
if the number of Internet protocol scans from the source exceeds the threshold, adjusting a traffic flow between a network controller and the network.

28. The machine-accessible medium of claim 27, wherein the adjusting the traffic flow includes automatically inhibiting the traffic flow between the network controller and the network.

29. The machine-accessible medium of claim 28, wherein there is further included determining whether the number of Internet protocol scans from the source is less than the threshold.

30. The machine-accessible medium of claim 29, wherein if the number of Internet protocol scans from the source remains greater than or equal to the threshold, there is further included:
disabling the traffic flow between the network controller and the network; and
transmitting an alarm indication to a network manager.
